(19) United States
(12) Patent Application Publication
(10) Pub. No.: US 2002/0191806 A1
(43) Pub. Date: Dec. 19, 2002

(54) Hearing aid system with a programmable hearing aid and a transmission and/or reception unit, a transmission and/or reception unit as well as a programmable hearing aid

(75) Inventors: Kristin Rohrseitz, Oberasbach (DE); Fred Zoels, Altenthann (DE)

Correspondence Address: SCHIFF HARDIN & WAITE, 6600 SEARS TOWER, 233 S WACKER DR, CHICAGO, IL, 60606-6473, US

(73) Assignee: Siemens Audiologische Technik GmbH

(21) Appl. No.: 10/105,584

(22) Filed: Mar. 25, 2002

(30) Foreign Application Priority Data
Mar. 30, 2001 (DE) 101 15 896.3

(51) Int. Cl. H04R 25/00

(52) U.S. Cl. 381/323; 381/314; 381/312

(57) ABSTRACT

In a hearing aid, a communication unit that is a transmission and/or reception unit detachably connected to the hearing aid is provided for wireless programming. This unit preferably comprises the external shape of a hearing aid battery and can be introduced into the battery compartment of the hearing aid for programming. As a result, components needed for the wireless programming of the hearing aid are only connected to the hearing aid during programming.

### BACKGROUND OF THE INVENTION

1. Field of the Invention

The invention is directed to a hearing aid system with a programmable hearing aid and a communication unit that may be a transmission and/or reception unit that comprises a mechanism for the transmission or reception of signals for a wireless programming of the hearing aid. The invention is also directed to a transmission and/or reception unit as well as to a programmable hearing aid.

2. Description of the Related Art

European patent document EP 0 448 764 A1 discloses a programmable hearing aid with a microphone, earphone, amplifier and transmission part that can be set to different transmission characteristics, a control unit with receiver and memory as well as with an external control device with memory, transmitter and programming device. For bidirectional signal transmission between the hearing aid and the programming device as well as for the transmission of data from the hearing aid back to the external control or programming unit, the receiver of the hearing aid and the transmitter of the external control device are fashioned to form receiver and transmitter parts for the wireless, bidirectional exchange of control signals using control logic that defines the transmission direction, this being implemented in order to avoid a galvanic coupling between control part and hearing aid.

The known wirelessly programmable hearing aid is disadvantageous because both the transmitter unit as well as the receiver unit are accommodated within the housing of the hearing aid and occupy space, and they also increase the power consumption of the hearing aid.

German patent document DE 195 41 648 A1 discloses an apparatus for transmitting programming data to hearing aid devices. This apparatus comprises a mobile transmission and reception module that can be contacted to a hearing aid to be worn behind the ear. The mobile transmission and reception module, together with a base module, transmission module and reception module, enables a wireless transmission of programming data between a PC and a hearing aid device.

### SUMMARY OF THE INVENTION

An object of the present invention is to provide a hearing aid system with a hearing aid and a wirelessly connectible transmission and/or reception unit, which does not affect the comfort of wearing the hearing aid during programming and that can also be applied for hearing aids worn in the ear.

In a hearing aid system having a programmable hearing aid and a transmission and/or reception unit detachably connectible to the hearing aid that comprises a mechanism for transmitting or receiving signals for wireless programming of the hearing aid, this object is achieved in that the transmission unit and/or reception unit comprises a housing that is fashioned for introduction into a battery compartment of the hearing aid.

Given a transmission unit and/or reception unit for the hearing aid system, the object is also achieved in that the housing for introduction into the battery compartment of the hearing aid at least primarily comprises the external shape of a hearing aid battery or of a hearing aid accumulator.

The object is also achieved in a programmable hearing aid for the hearing aid system by using a battery compartment for the acceptance and contacting of the transmission and/or reception unit.

For the wireless programming of a hearing aid, the invention provides a transmission and/or reception unit that is connected to the hearing aid only during programming; during normal operation of the hearing aid, a transmission and/or reception unit is not in the hearing aid itself. The unit(s) is attached in the hearing aid only for the duration of the programming. The space that is gained in the housing of the hearing aid is available for other components of the hearing aid or the hearing aid is constructed smaller in size—an attribute preferred by many hearing aid users. The lack of the transmission and/or reception unit in the hearing aid, reduces manufacturing costs and lower the power consumption of the hearing aid during normal operation.

Wireless programming of a programmable hearing aid requires at least some mechanism for receiving signals that emanate from an external programming device. In the wireless programming of a hearing aid, however, data are also usually transmitted from the hearing aid back to the programming device; this requires a transmission unit connected to the hearing aid.

The transmission and/or reception unit of the invention comprises its own housing in which the electronic components required for the transmission and/or reception are arranged and the transmission and/or reception unit in its own housing is arranged within the housing of the hearing aid during programming. There is no direct wire-bound connection to the external programming device and a portable transmission and/or reception unit also need not be worn on the body of the hearing aid user, so the use comfort of the hearing aid is also not deteriorated during programming. Programming can ensue quickly, simply and without burdensome wire-bound connections.

The invention provides that the housing of the transmission and/or reception unit comprises the shape of a hearing aid battery and can be introduced into the battery compartment of the hearing aid. This results in the hearing aid—during programming—not externally differing from the hearing aid in its normal condition of use. As a result, no components are present that could deteriorate the use comfort or the signal transmission behavior of the hearing aid during programming. Another advantage of this embodiment is that only comparatively few standard types of hearing aid batteries are marketed, so that a number of different hearing aid models can be programmed with a single transmission and/or reception unit in the form of a hearing aid battery. As a result, hearing aid acousticians need only keep a limited number of different transmission and/or reception units of the invention on hand in order to be able to program a multitude of different hearing aid models. This contributes to the acceptance on the part of the acousticians and for reducing the costs for the acousticians.

The battery compartment of the hearing aid is fashioned for the introduction of a transmission and/or reception unit of the invention such that further contacts that enable a data exchange between the transmission and/or reception unit at a signal processing unit in the hearing aid are present in addition to the contacts for the voltage supply. No connection or contact locations need be provided at the housing of the hearing aid given this embodiment. The transmission and/or reception unit has a voltage source for supplying voltage to the hearing aid during programming. This can be a battery but is preferably a rechargeable accumulator. Since the programming of a hearing aid is usually brief, it is sufficient to provide a smaller capacity voltage source within the transmission and/or reception unit of the invention than that normally provided for the battery compartment.

In a preferred development of the transmission and/or reception unit in the form of a hearing aid battery, a standard battery type (button cell) is provided as a voltage source within the transmission and/or reception unit. When the battery has been discharged, it can likewise be replaced or be recharged.

The invention can be employed given all known hearing aid types, for example, given hearing aids to be worn behind the ear, hearing aids to be worn in the ear, implantable hearing aids or pocket hearing aids. Furthermore, the hearing aid of the invention can also be part of a hearing aid system comprising a plurality of devices for serving a hearing-impaired person, for example, a hearing aid system having two hearing aids worn at the head for binaural coverage or a hearing aid system comprised of a device worn at the head and of a processing unit worn on the body.

### DESCRIPTION OF THE DRAWINGS

Further details of the invention are explained in greater detail below on the basis of exemplary embodiments.

FIG. 1 is a schematic block circuit diagram of a hearing aid in conjunction with a transmission and reception unit for wireless programming using a programming device that is likewise shown as a block circuit diagram;

FIG. 2 is a pictorial diagram of a hearing aid with a transmission and reception unit introduceable into the battery compartment;

FIG. 3 is a pictorial diagram plan view of an embodiment of a transmission and reception unit in battery form; and

FIG. 4 is a pictorial diagram side view of a further embodiment of a transmission and reception unit in battery form.

### DETAILED DESCRIPTION OF THE INVENTION

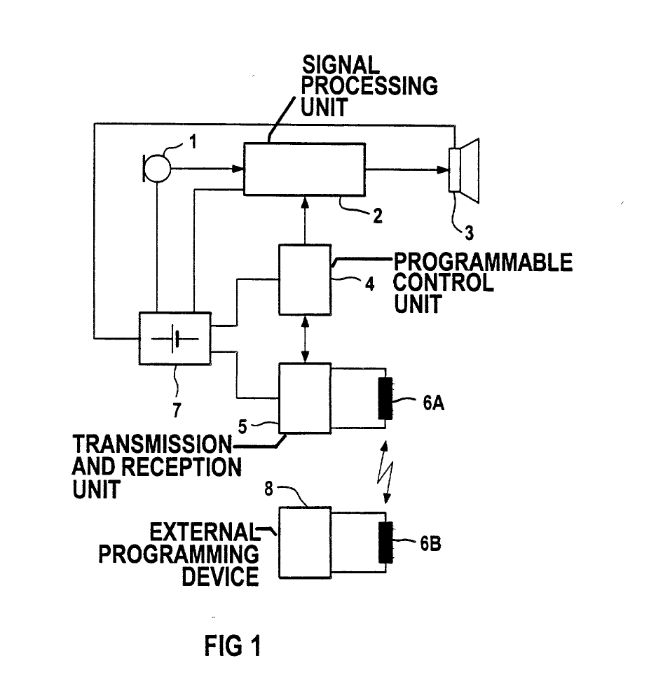

In a schematic illustration, FIG. 1 shows the block circuit diagram of a hearing aid having a microphone 1 for picking up an acoustic input signal and its conversion into an electrical input signal, having a signal processing unit 2 and having an earphone 3 for converting an electrical output signal into an acoustic output signal. A programmable control unit 4 that comprises a data memory (not shown) acts on the signal processing unit 2. Executive programs as well as setting parameters for the signal processing unit 2 can be deposited in the control unit 4, these being adaptable to different hearing impairments as well as to different auditory situations. For programming, a transmission and reception unit 5 is allocated to the hearing aid. This unit 5 is in communication with a transmission and reception coil 6A for wireless data transmission. A voltage source 7 serves as the energy supply of the components of the hearing aid as well as of the transmission and reception unit 5. In programming the hearing aid, data are edited in an external programming device 8 and are transmitted onto the transmission and reception coil 6A allocated to the hearing aid. This data is transmitted to the coil 6A via a transmission and reception coil 6B as electromagnetic waves. The data transmitted in this way—potentially following a further-processing—are transmitting onto the control unit 4 in the transmission and reception unit 5, this control unit 4 subsequently controlling the signal processing in the hearing aid according to the definitions communicated via the programming devices.

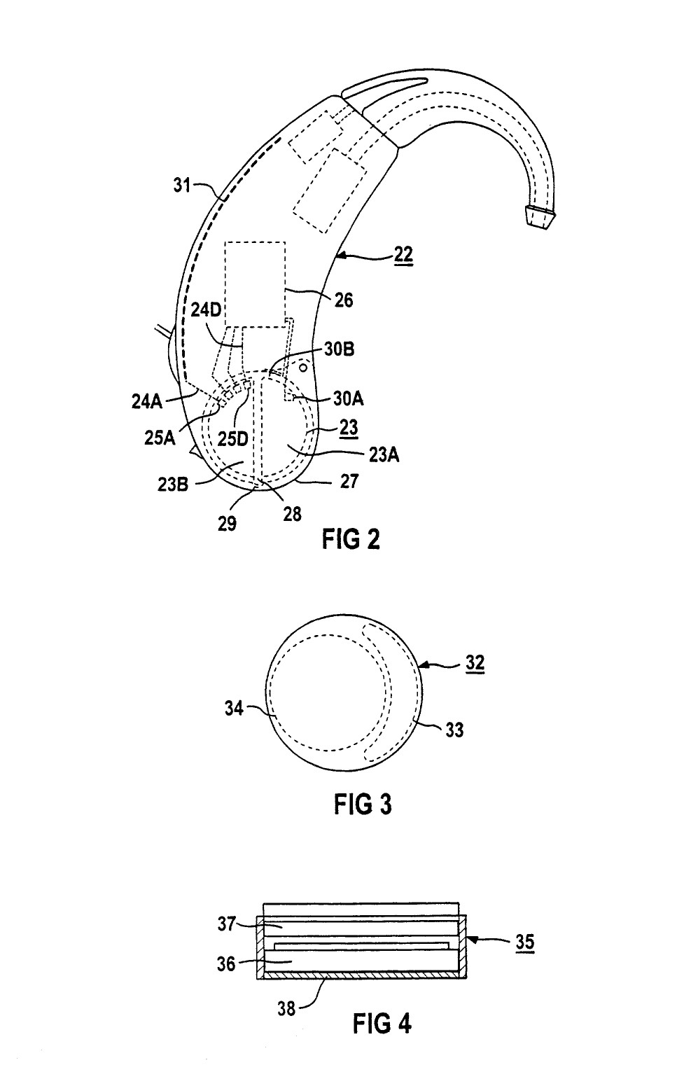

FIG. 2 shows an exemplary embodiment of the invention. The hearing aid 22 to be worn behind the ear is fashioned to accept a transmission and reception unit 23 having the exterior form of a hearing aid battery. The transmission and reception unit 23 is divided into two sub-regions. The voltage source for the voltage supply of the transmission and reception unit 23 as well as of the hearing aid 22 is arranged in the sub-region 23A, whereas the sub-region 23B comprises the transmission and reception electronics as well as contact pins 25A . . . 25D. Spring contacts 24A . . . 24D (only schematically shown in the drawing) provided in the hearing aid 22 contact these contact pins 25A . . . 25D at the upper side of the housing of the transmission and reception unit 23. For example, a data connection to the signal processing unit 26 is set up via the contacts and connected lines. The transmission and reception unit 23 can be introduced into the battery compartment 27 or removed from it like an ordinary hearing aid battery by opening a battery compartment 27 of the hearing aid 22. Differing from a battery, however, the transmission and reception unit 23 must be introduced into the battery compartment 27 of the hearing aid 22 with a specific alignment. A nose 28 is applied for this purpose to the housing of the transmission and reception unit 23, this engaging into a correspondingly negatively shaped recess 29 in the battery compartment 27. The hearing aid 22 also comprises contacts 30A and 30B for the voltage supply of the hearing aid 22.

An antenna 31 is integrated in the housing of the hearing aid 22 according to FIG. 2. This contacts the transmission and reception unit 23 via the contact pin 24A as well as the contact pin 25A at the upper side of the transmission and reception unit 23. The antenna 31 in the exemplary embodiment remains in the hearing aid 22 even when the transmission and reception unit 23 is removed.

FIG. 3 shows a schematic plan view of an example of the internal structure of the transmission and reception unit 32. An internal battery 34 is provided having a smaller diameter than the battery actually provided for the hearing aid. The housing of the transmission and reception unit 32 likewise comprises the form of a hearing aid battery. The space gained within the transmission and reception unit 32 due to the smaller structure of the battery 34 is available to accommodate transmission and reception electronics 33. The structural unit created in this way can thus be introduced into the battery compartment of a hearing aid, supplies the hearing aid as well as itself with electrical energy, and is suitable for the wireless data exchange with an external programming device as well as the signal processing unit of the hearing aid.

FIG. 4 is a schematic side view of another embodiment of a transmission and reception unit 35 comprising an internal battery 36 or accumulator. Due to the slight structural height of the selected battery 36, there is still adequate space above the battery in order to accept the transmission and reception electronics 37 within. As another example, the transmission and reception unit 35 shown in FIG. 4 comprises a removable housing cover 38. This makes it possible to remove a dead battery 36 and replace it with a new one. Only the fundamental arrangement of the components has been shown in the Figures of the drawings. Details (signal lines, contacts, etc.) have been foregone in favor of greater clarity.

No limitation of the scope of the invention is intended by this specific language, and the invention should be construed to encompass all embodiments that would normally occur to one of ordinary skill in the art. Use of the word mechanism does not infer a physical mechanical device but rather encompasses any generic mechanism, hardware or software.

The functional block components and various processing steps of the invention may be realized by any number of hardware and/or software components configured to perform the specified functions. For example, the present invention may employ various integrated circuits or components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like.

The particular implementations shown and described above are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

LIST OF REFERENCE CHARACTERS

| | |
|---|---|
| 1 | microphone |
| 2 | signal processing unit |
| 3 | earphone |
| 4 | control unit |
| 5 | transmission and reception unit |
| 6A, 6B | transmission and reception coil |
| 7 | voltage source |
| 8 | programming device |
| 22 | hearing aid |
| 23 | transmission and reception unit |
| 23A, 23B | sub-regions of the transmission and reception unit |
| 24A . . . D | contact pins |
| 25A . . . D | contact pins |
| 26 | signal processing unit |
| 27 | battery compartment |
| 28 | nose |
| 29 | recess |
| 30A, 30B | contacts |
| 31 | antenna |
| 32 | transmission and reception unit |
| 33 | battery |
| 34 | transmission and reception electronics |
| 35 | transmission and reception unit |
| 36 | battery |
| 37 | transmission and reception electronics |
| 38 | cover |

What is claimed is:

1. A hearing aid system, comprising:
a programmable hearing aid;
a communication unit which is at least one of a transmission unit and a reception unit, the communication unit being detachably connectable to the hearing aid and is configured to transmit or receive signals for wirelessly programming the hearing aid, the communication unit comprising a housing that is fashioned for introduction into a battery compartment of the hearing aid.

2. A communication unit which is at least one of a transmission unit and a reception unit for a hearing aid system, comprising a housing for introducing the communication unit into a battery compartment of a programmable hearing aid of the hearing aid system, the housing significantly comprising the external shape of a hearing aid battery or accumulator.

3. The communication unit according to claim 2, further comprising a voltage source for supplying voltage to the communication unit and the hearing aid.

4. The communication unit according to claim 3, wherein the voltage source is fashioned as an accumulator.

5. The communication unit according to claim 3, wherein the voltage source is fashioned as a standard voltage source having a smaller structural size compared to a structural size prescribed by the battery compartment of the hearing aid.

6. The communication unit according to claim 2, further comprising contacts configured to connect voltage supply lines and data lines of the hearing aid.

7. A programmable hearing aid for a hearing aid system, comprising:
a battery compartment configured to accept and contact a communication unit which is at least one of a transmission and reception unit.

8. The programmable hearing aid according to claim 7, further comprising:
a voltage supply located within the communication unit that supplies both the communication unit and the hearing aid when the communication unit is introduced into the hearing aid.

9. The programmable hearing aid according to claim 7, further comprising an antenna connectable to the communication unit.

10. A method for programming a hearing aid, comprising:
providing a programmable hearing aid having a battery compartment holding a battery or an accumulator;
removing the battery or accumulator from the hearing aid;
introducing a communication unit into the battery compartment, the communication unit being at least one of a transmission unit and a reception unit and configured to fit within the battery compartment;
transmitting or receiving signals from the communication unit to the hearing aid;
removing the communication unit from the hearing aid; and
replacing the battery or accumulator in the hearing aid.

11. The method according to claim 10, further comprising:
transmitting or receiving signals by the communication unit from an external programming device.

12. The method according to claim 10, further comprising:
providing power to both the communication device and the hearing aid from a common voltage source located within the communication device.
